(19) United States
(12) Patent Application Publication
(10) Pub. No.: US 2023/0393409 A1
(43) Pub. Date: Dec. 7, 2023

(54) Optical Beam Splitter, Optical System, and Microscope

(71) Applicant: Leica Instruments (Singapore) Pte. Ltd., Singapore (SG)

(72) Inventor: Gao YANG, Singapore (SG)

(21) Appl. No.: 18/249,981

(22) PCT Filed: Oct. 15, 2021
(86) PCT No.: PCT/EP2021/078649

§ 371 Date: Apr. 21, 2023

(30) Foreign Application Priority Data
Oct. 23, 2020 (DE) 10 2020 128 009.2

(51) Int. Cl. G02B 27/14; G02B 21/18

(52) U.S. Cl. CPC G02B 27/144; G02B 21/18

(57) ABSTRACT

An optical beam splitter including an at least partially semi-transparent layer. The at least partially semi-transparent layer includes at least one first region having a first transmission coefficient and a first reflection coefficient for visible light and at least one second region having a second transmission coefficient for visible light. The first transmission coefficient is larger than 0 and the first reflection coefficient is larger than 0. The second transmission coefficient differs from the first transmission coefficient. The optical beam splitter is configured so that visible light passing the at least partially semi-transparent layer through the at least one first region propagates along a first optical output path of the optical beam splitter and visible light reflected by the at least one first region propagates along a second optical output path of the optical beam splitter.

### FIELD

The present disclosure generally relates to an optical beam splitter, an optical system, and a microscope.

### BACKGROUND

Optical beams splitters are a crucial part of many optical experimental and measurement systems, such as interferometers and microscopes, also finding widespread application in fiber optic telecommunications. Another application of optical beam splitters are optical surgical microscopes.

The optical beam splitter is an optical device that splits a beam of light in two separate beams with different optical output paths. Optical beam splitters are used for example to direct in-coming light to an ocular and a camera.

### SUMMARY

There may be a need to provide an improved optical beam splitter, which may provide a better view, an extended DoF and/or might waste less light.

This need is addressed by the subject matter of the independent claim.

An example relates to an optical beam splitter comprising an at least partially semi-transparent layer. The at least partially semi-transparent layer comprises at least one first region having a first transmission coefficient and a first reflection coefficient for visible light and at least one second region having a second transmission coefficient for visible light. The first transmission coefficient is larger than 0 and the first reflection coefficient is larger than 0. The second transmission coefficient differs from the first transmission coefficient. The optical beam splitter is configured so that visible light passing the at least partially semi-transparent layer through the at least one first region propagates along a first optical output path of the optical beam splitter and visible light reflected by the at least one first region propagates along a second optical output path of the optical beam splitter. The at least partially semi-transparent layer may allow both the first optical output path and the second optical output path to be operational at the same time, an extended DoF and/or less light intensity is wasted, for example to a light-blocking diaphragm. Thereby, the optical beam splitter may provide a better view.

In some embodiments the second transmission coefficient may differ at least by 20% from the first transmission coefficient. This may enable providing a light distribution at the first and the second optical output path, which is suitable for a given application.

In at least some embodiments the first transmission coefficient may be larger than 0.2 and the first reflection coefficient is larger than 0.2. This may enable providing enough visible light along the first optical output path and the second optical output path of the optical beam splitter. The first transmission and the first reflection coefficients may depend on application.

For example, the second transmission coefficient may be larger than 0.8. In this case the light distribution of the first and the second optical output path may be further adapted to the given application. Also, the second transmission coefficient may depend on application.

In some embodiments the at least partially semi-transparent layer may be a planar layer. In this case the at least partially semi-transparent layer may be provided, which may be easy to produce and may be suitable for various applications.

In order to improve the above optical beam splitter, an output direction of the first optical output path may differ by at most 20° from an input direction of an optical input path of the optical beam splitter for receiving visible light and an output direction of the second optical output path may differ by at least 70° from the input direction. This may enable adapting an orientation of the first and the second optical output paths to a given application.

In at least some embodiments an angle between the at least partially semi-transparent layer and an input direction of an optical input path of the optical beam splitter for receiving visible light may be at least than 30° and at most 60°. In this case an orientation of the optical beam splitter to the optical input path may be adapted to a given application.

In order to improve the above optical beam splitter, in embodiments the at least one first region may be part of a coded pattern of the at least partially semi-transparent layer. The coded pattern may enable the extraction of information concerning a depth of an imaged object from visible light passing the optical beam splitter. In this case it may be possible to extract information concerning the depth of the imaged object as well as a sharp image.

In some embodiments the at least one first region may have an oval shape. The oval shape may correspond to a circle when projected to an input or output surface and may function as an iris to control the depth of focus. The depth of focus may measure a tolerance of a place-ment of an image sensor. Alternatively, the at least one first region may be shaped circular. The at least one first region may be shaped in form of an aperture. The aperture may be at least essentially arranged in the middle of the at least partially semi-transparent layer. Alternatively, the at least one first region may be shaped in form of a pattern. The pattern may comprise at least one polygon. This may enable providing different embodiments of the at least one first region suitable for different applications.

In at least some embodiments the at least one first region may be completely surrounded by the at least one second region. In this case the at least one first region may be adapted to the given application.

For example, an optical system may comprise: an optical beam splitter as described above; and an image sensor. The second optical output path of the optical beam splitter may extend to the image sensor. In this case it may be possible to display an image created by the image sensor on a display.

Additionally, the optical system according may further comprise a processing circuit configured to determine a depth of at least a part of an imaged object based on a coded pattern of the at least partially semi-transparent layer. This may enable providing an information concerning the depth of at least a part of the imaged object as well as a sharp image.

In some embodiments the optical system may further comprise a diaphragm, wherein the diaphragm is arranged in the second optical output path between the optical beam splitter and the image sensor. This may enable regulating the amount of visible light that passes the image sensor.

In at least some embodiments the optical system according may further comprise an ocular. The first optical output path of the optical beam splitter may extend to the ocular. In this case the user may choose between using the ocular or the display.

Embodiments of the present disclosure further provide a microscope, which may comprise an optical system described above. The microscope may be suitable for different applications for example surgery. This may enable providing a microscope suitable for a specific given application.

### BRIEF DESCRIPTION OF THE FIGURES

Some examples of apparatuses and/or methods will be described in the following by way of example only, and with reference to the accompanying figures, in which

FIG. 1 shows a schematic view of an optical system according to an embodiment of the present disclosure;

FIG. 2 shows a schematic view of an optical beam splitter according to another embodiment of the present disclosure;

FIG. 3 shows a schematic view of an optical beam splitter according to another embodiment of the present disclosure;

FIG. 4 shows a schematic view of an optical beam splitter according to another embodiment of the present disclosure;

FIG. 5 shows a schematic view of a system comprising a microscope and a computer system.

### DETAILED DESCRIPTION

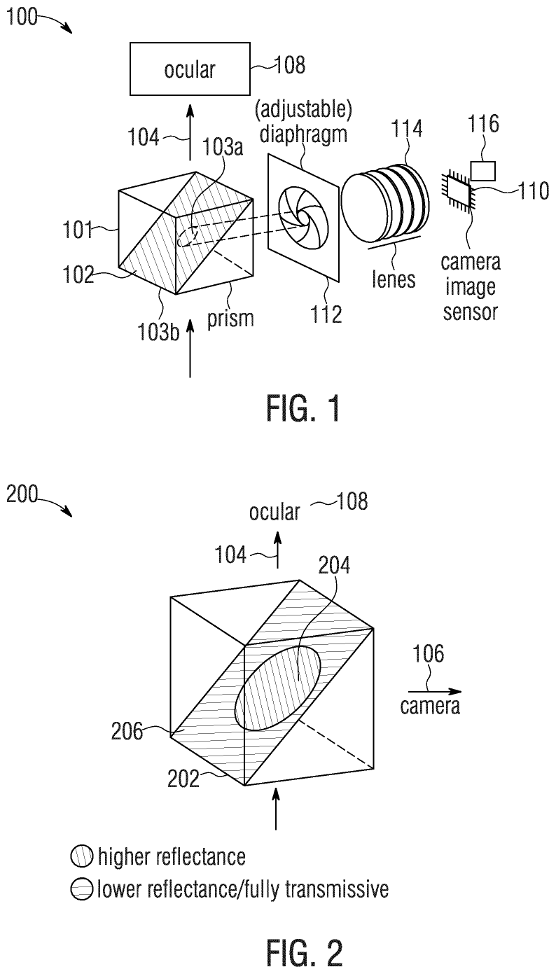

FIG. 1 shows a schematic view of an optical system 100 according to an embodiment of the present disclosure. The optical system 100 comprises an optical beam splitter 101. The optical beam splitter 101 comprises an at least partially semi-transparent layer 102. The at least partially semi-transparent layer 102 comprises at least one first region 103a having a first transmission coefficient and a first reflection coefficient for visible light and at least one second region 103b having a second transmission coefficient for visible light. The first transmission coefficient is larger than 0 and the first reflection coefficient is larger than 0. The second transmission coefficient differs from the first transmission coefficient. The optical beam splitter 101 is configured so that visible light passing the optical beam splitter 101 propagates along a first optical output path 104 of the optical beam splitter 101 and visible light reflected by the optical beam splitter 101 propagates along a second optical output path 106 of the optical beam splitter 101. The optical system 100 may further comprise an ocular 108. The first optical output path 104 of the optical beam splitter 101 extends to the ocular 108. The optical system 100 further comprises an image sensor 110. The second optical output path 106 of the optical beam splitter 101 extends to the image sensor 110. The optical system 100 may further comprise a mechanical diaphragm 112 and/or at least one lens 114. The mechanical diaphragm 112 and/or the at least one lens 114 may be arranged in the second optical output path 106 before the image sensor 110. The mechanical diaphragm 112 may be adjustable and is used to cut out off-axis light to increase depth of field. The mechanical diaphragm 112 may control a depth of field, DoF. DoF is the distance between the nearest and furthest elements in a scene that appear to be at least essentially acceptably sharp in an image.

The at least one first region 103a may be shaped for example in form of a coded pattern. The coded pattern may enable a simultaneous recovery of both a high-resolution image and the extraction of information concerning the depth of the imaged object, such as a depth estimation.

The optical system 100 may further comprise a processing circuit 116, which is connected with the image sensor 110, configured to determine a depth of at least a part of an imaged object based on the coded pattern of the at least partially semi-transparent layer 102. The processing circuit 116 may comprise a processor.

More details and aspects are mentioned in connection with the embodiments described above or below. The example shown in FIG. 1 may comprise one or more optional additional features.

FIG. 2 shows a schematic view of an optical beam splitter 200 according to an embodiment of the present disclosure. The optical beam splitter 200 comprising an at least partially semi-transparent layer 202. The at least partially semi-transparent layer 202 comprises at least one first region 204 having a first transmission coefficient and a first reflection coefficient for visible light and at least one second region 206 having a second transmission coefficient for visible light.

The first transmission coefficient is larger than 0 and the first reflection coefficient is larger than 0. For example, the first transmission coefficient may be larger than 0.2 (alternatively for example at least 0.25, at least 0.3, at least 0.35, at least 0.4, at least 0.45 or at least 0.5) and/or the first reflection coefficient may be larger than 0.2 (alternatively for example at least at least 0.3, at least 0.35, at least 0.4, at least 0.45 or at least 0.5). The second transmission coefficient differs from the first transmission coefficient. For example, the second transmission coefficient may differ at least by 20% from the first transmission coefficient (alternatively for example by at least 25%, at least 30%, at least 35%, at least 40%, at least 45% or at least 50%). The second transmission coefficient may be larger than 0.8 (alternatively for example at least 0.5, at least 0.55, at least 0.6, at least 0.65, at least 0.7, at least 0.75, at least or at least 0.9).

The at least one first region 204 may have an oval shape, a circular shape, a polygonal shape or a coded pattern. For example, an oval shape may be obtained by projecting the largest desirable circular aperture outline at a 45-degree angle. Alternatively, the at least one first region may be shaped circular or may have any shape, which is required by a given application, for example in form of a pattern. The pattern may comprise at least one geometric shape, for example a polygon. The at least one first region 204 may be shaped in form of an aperture. The aperture may be at least essentially arranged in the middle of the at least partially semi-transparent layer 202. The at least one first region 204 may be completely surrounded by the at least one second region 206. For example, the at least partially semi-transparent layer 202 may comprise only one first region 204 completely surrounded by only one second region 206.

The at least partially semi-transparent layer 202 may comprise at least one same transparent region, while other regions may be transparent or opaque. Alternatively, the whole layer may be semi-transparent, but with laterally varying transparency. At least partially semi-transparent layer 202 may mean that at least one lateral region of the layer 202 is semi-transparent, other lateral regions might or might not be transparent or opaque. For example, the at least partially semi-transparent layer 202 may be a layer with patterned nonuniform reflectivity. The pattern may be or may comprise a circular shape, an oval shape or a coded pattern, for example.

The at least partially semi-transparent layer 202 may be a planar layer. Alternatively, the at least partially semi-transparent layer 202 may have laterally varying thickness. The at least partially semi-transparent layer 202 may be a coating (e.g. with a spatial-variant reflectance) on a substrate, may be grown on a substrate or may be a modified surface region of a substrate. The substrate may be transparent. The substrate may have a prism shape or another suitable geometry.

The optical beam splitter 200 is configured so that visible light passing the at least partially semi-transparent layer 202 through the at least one first region 204 propagates along a first optical output path 104 of the optical beam splitter 200 and visible light reflected by the at least one first region 204 propagates along a second optical output path 106 of the optical beam splitter 200. The first optical output path 104 of the optical beam splitter 200 may extend to the ocular 108. The second optical output path 106 of the optical beam splitter 200 may extend to an image sensor 110 of a camera. The image sensor 110 may be a CCD (charge-coupled device) sensor or an active-pixel sensor. Alternatively, other image sensors may be used.

An output direction of the first optical output path 104 may differ by at most 20° (or at most from an input direction of an optical input path of the optical beam splitter 200 for receiving visible light. For example, the output direction of the first optical output path 104 may be parallel to the input direction. An output direction of the second optical output path 106 may differ by at least 70° (or at least 80°) from the input direction. For example, the output direction of the second optical output path 106 may be orthogonal to the input direction. An angle between the at least partially semi-transparent layer 202 and an input direction of an optical input path of the optical beam splitter 200 for receiving visible light may be at least than 30° (or at least 40°) and at most 60° (or at most 50°). For example, the angle between the at least partially semi-transparent layer 202 and the input direction may be 45°.

For example, the at least partially semi-transparent layer 202 may be arranged so that a first portion of light received from an input direction of the optical beam splitter 200 passes through the at least one first region 204 of the at least partially semi-transparent layer 202 and exits the optical beam splitter 200 in a first output direction of the optical beam splitter 200. Further, the at least partially semi-transparent layer 202 may be arranged so that a second portion of light received from the input direction of the optical beam splitter passes through the at least one second region 206 of the at least partially semi-transparent layer 202 and exits the optical beam splitter 200 in the first output direction of the optical beam splitter 200. The at least partially semi-transparent layer 202 arranged so that a third portion of light received from the input direction of the optical beam splitter 200 is reflected at the at least one first region 204 of the at least partially semi-transparent layer 202 and exits the optical beam splitter 200 in a second output direction of the optical beam splitter 200.

The first reflection coefficient of the at least one first region 204 may be at least 0.2 (or at least 0.4) and/or at most 0.8 (or at most 0.6 or at most 0.4). For example, the first reflection coefficient may be 0.5. The at least partially semi-transparent layer 202 may comprise only one first region 204 or two or more first regions 204 having the first transmission coefficient and the first reflection coefficient. The at least one second region 206 may have a lower reflectance as the at least one first region 204, which may have a higher reflectance. The at least one second region 206 may have a second reflection coefficient, which may be 0 (or at most at most 0.1, at most 0.15, at most 0.2, at most 0.25 or at most 0.3). If the at least one second region 206 may have a second reflection coefficient equal to 0 or closer to 0, the at least one second region 206 may be completely or nearly completely transparent. This may enable providing a smaller effective iris to the image sensor 110 and an extended depth of field. This iris in the beam splitter may be used so that the light either may go to the camera or the oculars, instead of being absorbed by diaphragms used by other concepts. The at least one first region 204 should reflect enough visible light to the image sensor 110 for a clear image. The remaining visible light will go to the ocular 108. The at least partially semi-transparent layer 202 may comprise only one second region 206 or two or more second regions 206 having the second transmission coefficient and the second reflection coefficient.

The optical beam splitter 200 may have for example a cuboid or cube shape, in particular the optical beam splitter 200 may be a filter cube. Alternatively, the optical beam splitter 200 may have any shape, which is required by a given application. The optical beam splitter 200 may comprise a first prism and a second prism. The first and the second prism may have a base area with a shape of an equilateral triangle. The first prism may have a first contact region. The first contact region may be an outer surface of the first prism, perpendicular to the base area of the first prism, and may extend along a hypotenuse of the base area of the first prism. The second prism may have a second contact region. The second contact region may be an outer surface of the second prism, perpendicular to the base area of the second prism, and may extend along a hypotenuse of the base area of the second prism. The first contact region and the second contact region may be arranged facing each other. The at least partially semi-transparent layer 202 may be arranged between the first contact region of the first prism and the second contact region of the second prism. The at least partially semi-transparent layer 202 may be formed before the first prism and the second prism are joined. The at least partially semi-transparent layer 202 might not be changed afterwards. If a different shape of the at least one first region 204 may be needed, the optical beam splitter 200 may be replaced. By using the first and the second prism, the first optical output path 103 to the ocular 108 may be enabled.

An embodiment may further relate to an optical system. The optical system may comprise an optical beam splitter 200 as described above and an image sensor 110. The second optical output path 106 of the optical beam splitter 200 may extend to the image sensor 110. The optical system may further comprise a display connected to the image sensor 110. This may enable displaying an image taken by the image sensor 110.

The optical system may further comprise a diaphragm 112. The diaphragm 112 may be a thin opaque structure with an opening, such as an aperture, at its centre. The diaphragm 112 may be a type of adjustable diaphragm 112 known as an iris diaphragm, and often referred to as an iris. The diaphragm 112 may be used to stop the passage of light, except for the light passing through the aperture. The diaphragm 112 may be arranged in the second optical output path 106 between the optical beam splitter 200 and the image sensor 110. This may enable regulating with the size of the aperture the amount of visible light that passes to the image sensor 110. The diaphragm 112 may control a depth of field, DoF. Between the diaphragm 112 and the image sensor 110 at least one lens 114 may be arranged in the second optical output path 106. A center of the diaphragm's aperture may coincide with an optical axis of the at least one lens 114.

The optical system may further comprise the ocular 108. The first optical output path 104 of the optical beam splitter 200 may extend to the ocular 108. This may enable providing an eyepiece to a user.

Another embodiment may relate to a microscope. The microscope may comprise an optical system as described above. The microscope may enable to an improved view of an imaged object. A possible application may be a surgical microscope, in particular a hybrid surgical microscope, which enables a user to look either through the ocular 108 or at the display while performing surgery. Alternatively, the microscope may also be suitable for other application. For example, the optical beam splitter 200 may comprise a patterned prism coating (e.g. used for a hybrid surgical microscope).

More details and aspects are mentioned in connection with the embodiments described above or below. The example shown in FIG. 2 may comprise one or more optional additional features.

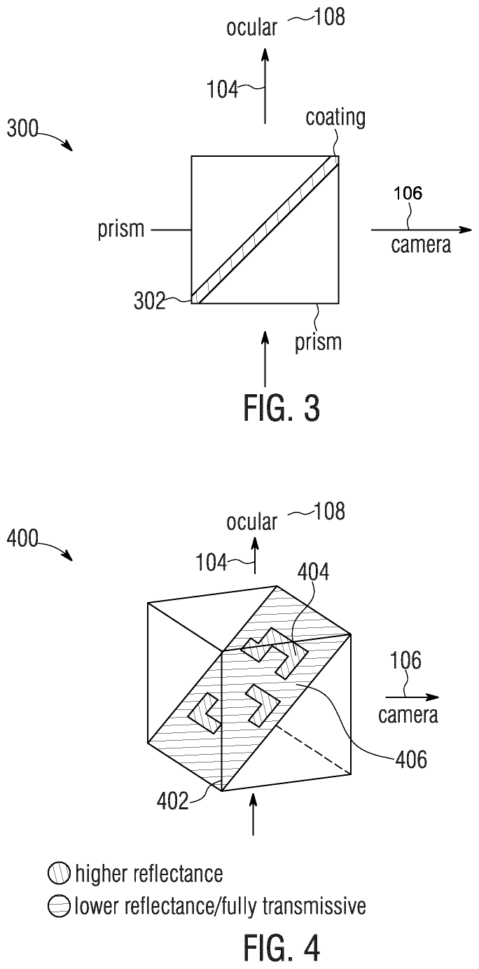

FIG. 3 shows a schematic view of the optical beam splitter 300 according to an embodiment of the present disclosure. The optical beam splitter 300 may be implemented similar to the optical beam splitter described in connection with FIG. 2. The at least partially semi-transparent layer 302 is implemented as a coating, in particular with a spatial-variant reflectance. The coating may be applied to the first contact region of the first prism. Alternatively, the coating may be applied to the second contact region of the second prism. The coating may be depos-ited on the first contact region or the second contact region using chemical vapor deposition, CVD or physical vapor deposition, PVD. Nevertheless, also other techniques for example chemical and electrochemical techniques, spraying, roll-to-roll coating processes or physical coating processes may be used to apply the coating to the first contact region or the second contact region.

More details and aspects are mentioned in connection with the embodiments described above or below. The example shown in FIG. 3 may comprise one or more optional additional features.

FIG. 4 shows a schematic view of an optical beam splitter 400 according to an embodiment of the present disclosure. The optical beam splitter 400 may be implemented similar to the optical beam splitter described in connection with FIG. 2 or 3. The at least one first region 404 of the at least partially semi-transparent layer 402 is shaped in form of a coded pattern. The pattern may comprise at least one polygon. For example, the pattern may comprise two, three or more polygons.

The at least one first region 404 may be part of a coded pattern of the at least partially semi-transparent layer 402. The optical beam splitter 400 directing light to the ocular 108 and the image sensor 110 comprising the at least partially semi-transparent layer 402, which is con-structed as a spatially-varying reflective coating, so that the beams are not simply split at a uniform ratio but are given optical features of the coated pattern. The coating may also contain coded patterns, which are like a coded aperture, that may allow an optical system to recover depth information mathematically. The coded pattern may enable a simultaneous recovery of both a high-resolution image and the extraction of information concerning the depth of the imaged object, such as a depth estimation. The depth and the image may be inferred from a single shot without additional user requirements and without loss of image quality. Further-more, the coded pattern may enable a depth-of-field extension. The depth of field extensions may enable extending the depth of field without sacrificing resolution or brightness.

The coded pattern may produce a characteristic distribution of image frequencies that is very sensitive to the exact scale of defocus blur. The depth of the imaged object may be directly computed, and the captured image may be decoded. An effect of defocus may be controlled so that it may be possible to both estimate the amount of defocus easily, and hence infer distance information, while at the same time making it possible to compensate for at least part of the defocus to create artifact-free images. The impact of the coded pattern on the image may be minimal in an in-focus area. In an out-of-focus area, point-like high contrast texture may take up the shape of the coded aperture instead of a disk.

A coded aperture may be designed based on a mathematical model as a filter selection criterion. The filter selection criterion may give a likelihood of a blurry input image for a filter at a scale. This may be used to measure the robustness of a particular aperture filter at identifying a true blur scale.

The resulting sharp image and a layered depth map, which may be produced with the information of the depth on the imaged objects, may be combined for various photographic applications, including automatic scene segmentation, post-exposure refocusing, or re-rendering of the scene from an alternate viewpoint.

Another embodiment may relate to an optical system. The optical system corresponds to the optical system described above. The optical system may further comprise a processing circuit 116 configured to determine the depth of at least a part of the imaged object based on a coded pattern of the at least partially semi-transparent layer 402. The processing circuit 116 may comprise a processor.

More details and aspects are mentioned in connection with the embodiments described above or below. The example shown in FIG. 4 may comprise one or more optional additional features.

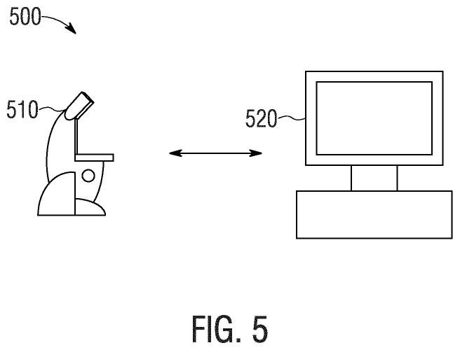

FIG. 5 shows a schematic illustration of a system 500 configured to perform a method described herein. The system 500 comprises a microscope 510 and a computer system 520. The microscope 510 may comprise an optical beam splitter and/or an optical system as described above. The computer system may comprise a processing circuit as described above. The microscope 510 is configured to take images and is connected to the computer system 520. The computer system 520 is configured to execute at least a part of a method described herein. The computer system 520 and microscope 510 may be separate entities but can also be integrated together in one common housing. The computer system 520 may be part of a central processing system of the microscope 510 and/or the computer system 520 may be part of a subcomponent of the microscope 510, such as a sensor, an actor, a camera or an illumination unit, etc. of the microscope 510.

The computer system 520 may be a local computer device (e.g. personal computer, laptop, tablet computer or mobile phone) with one or more processors and one or more storage devices or may be a distributed computer system (e.g. a cloud computing system with one or more processors and one or more storage devices distributed at various locations, for example, at a local client and/or one or more remote server farms and/or data centers). The computer system 520 may comprise any circuit or combination of circuits. In one embodiment, the computer system 520 may include one or more processors which can be of any type. As used herein, processor may mean any type of computational circuit, such as but not limited to a microprocessor, a microcontroller, a complex instruction set computing (CISC) microprocessor, a reduced instruction set computing (RISC) microprocessor, a very long instruction word (VLIW) microprocessor, a graphics processor, a digital signal processor (DSP), multiple core processor, a field programmable gate array (FPGA), for example, of a microscope or a microscope component (e.g. camera) or any other type of processor or processing circuit. Other types of circuits that may be included in the computer system 520 may be a custom circuit, an application-specific integrated circuit (ASIC), or the like, such as, for example, one or more circuits (such as a communication circuit) for use in wireless devices like mobile telephones, tablet computers, laptop computers, two-way radios, and similar electronic systems. The computer system 520 may include one or more storage devices, which may include one or more memory elements suitable to the particular application, such as a main memory in the form of random access memory (RAM), one or more hard drives, and/or one or more drives that handle removable media such as compact disks (CD), flash memory cards, digital video disk (DVD), and the like. The computer system 520 may also include a display device, one or more speakers, and a keyboard and/or controller, which can include a mouse, trackball, touch screen, voice-recognition device, or any other device that permits a system user to input information into and receive information from the computer system 520.

More details and aspects are mentioned in connection with the embodiments described above or below. The example shown in FIG. 5 may comprise one or more optional additional features.

Other concepts may relate to optical beam splitters with a uniform coating of a certain reflectance. The uniform coating of a certain reflectance may determine how much light goes to the camera while the remaining light goes to the ocular. Diaphragms are sometimes added to either optical output path to control the depth of field, DoF. DoF is the distance between the nearest and furthest elements in a scene that appear to be at least essentially acceptably sharp in an image. The diaphragm may block light to the cameras or the ocular and thereby reducing the light intensity. This may downgrade a view at the camera or the ocular.

As used herein the term “and/or” includes any and all combinations of one or more of the associated listed items and may be abbreviated as “/”.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

### REFERENCE SIGNS

100 optical system;
101 optical beam splitter;
102 at least partially semi-transparent layer;
103a at least one first region;
103b at least one second region;
104 first optical output path;
106 second optical output path;
108 ocular;
110 image sensor;
112 diaphragm;
114 lens;
116 processing circuit;
200 optical beam splitter;
202 at least partially semi-transparent layer;
204 at least one first region;
206 at least one second region;
300 optical beam splitter;
302 at least partially semi-transparent layer;
400 optical beam splitter;
402 at least partially semi-transparent layer;
404 at least one first region;
406 at least one second region;
500 system;
510 microscope;
520 computer system.

1. A microscope comprising an optical system, the optical system comprising:
an optical beam splitter comprising an at least partially semi-transparent layer, wherein the at least partially semi-transparent layer comprises at least one first region having a first transmission coefficient and a first reflection coefficient for visible light and at least one second region having a second transmission coefficient for visible light, wherein the first transmission coefficient is larger than 0 and the first reflection coefficient is larger than 0, wherein the second transmission coefficient differs from the first transmission coefficient, wherein the optical beam splitter is configured so that visible light passing the at least partially semi-transparent layer through the at least one first region propagates along a first optical output path of the optical beam splitter and visible light reflected by the at least one first region propagates along a second optical output path of the optical beam splitter;
an image sensor, wherein the second optical output path of the optical beam splitter extends to the image sensor; and an ocular, wherein the first optical output path of the optical beam splitter extends to the ocular.

2. The microscope according to claim 1, wherein the second transmission coefficient differs at least by 20% from the first transmission coefficient.

3. The microscope according to claim 1, wherein the first transmission coefficient is larger than 0.2 and the first reflection coefficient is larger than 0.2.

4. The microscope according to claim 1, wherein the second transmission coefficient is larger than 0.8.

5. The microscope according to claim 1, wherein the at least partially semi-transparent layer is a planar layer.

6. The microscope according to claim 1, wherein an output direction of the first optical output path differs by at most 20° from an input direction of an optical input path of the optical beam splitter for receiving visible light and an output direction of the second optical output path differs by at least 70° from the input direction.

7. The microscope according to claim 1, wherein an angle between the at least partially semi-transparent layer and an input direction of an optical input path of the optical beam splitter for receiving visible light is at least than 30° and at most 60°.

8. The microscope according to claim 1, wherein the at least one first region is part of a coded pattern of the at least partially semi-transparent layer, wherein the coded pattern enables the extraction of information concerning a depth of an imaged object from visible light passing the optical beam splitter.

9. The microscope according to claim 1, wherein the at least one first region has an oval shape.

10. The microscope according to claim 1, wherein the at least one first region is completely surrounded by the at least one second region.

11. The microscope according to claim 1, further comprising a processing circuit configured to determine a depth of at least a part of an imaged object based on a coded pattern of the at least partially semi-transparent layer.

12. The microscope according claim 1, further comprising a diaphragm, wherein the diaphragm is arranged in the second optical output path between the optical beam splitter and the image sensor.

13. The microscope according claim 1, wherein the optical beam splitter comprises a cube shape.

14. An optical beam splitter comprising an at least partially semi-transparent layer, wherein the at least partially semi-transparent layer comprises at least one first region having a first transmission coefficient and a first reflection coefficient for visible light and at least one second region having a second transmission coefficient for visible light, wherein the first transmission coefficient is larger than 0 and the first reflection coefficient is larger than 0, wherein the second transmission coefficient differs from the first transmission coefficient, wherein the optical beam splitter is configured so that visible light passing the at least partially semi-transparent layer through the at least one first region propagates along a first optical output path of the optical beam splitter and visible light reflected by the at least one first region propagates along a second optical output path of the optical beam splitter, wherein the at least one first region is part of a coded pattern of the at least partially semi-transparent layer, wherein the coded pattern enables the extraction of information concerning a depth of an imaged object from visible light passing the optical beam splitter.
